(19) United States
(12) Patent Application Publication
(10) Pub. No.: US 2016/0332511 A1
(43) Pub. Date: Nov. 17, 2016

(54) MOUNTING ASSEMBLY

(71) Applicant: Caterpillar Inc., Peoria, IL (US)

(72) Inventors: Joshua D. Hicke, Morton, IL (US); Christopher R. Beasley, Peoria, IL (US); Andrew C. Boen, Peoria, IL (US)

(73) Assignee: Caterpillar Inc., Peoria, IL (US)

(21) Appl. No.: 15/219,153

(22) Filed: Jul. 25, 2016

(51) Int. Cl. B60K 5/12

(52) U.S. Cl. CPC B60K 5/12; E21C 29/22

(57) ABSTRACT

A mounting assembly for mounting an engine of a machine is provided. The mounting assembly includes a bracket having a first portion. The first portion is adapted to attach to a frame of the machine. A second portion is coupled to the first portion. The second portion includes a first member having a first end. The first end includes a first annular opening. A second member includes a second end having a second annular opening. A third member is sandwiched between the first member and the second member. The third member having a third end and a first surface. The first surface is indicative of a curved surface. The first end, the second end, and the third end are being coplanar with each other. The bracket is manufactured as a single component, and is disposed on the frame of the machine at a predetermined angle to mount the engine.

### TECHNICAL FIELD

The present disclosure relates to a mounting assembly for mounting an engine of a machine.

### BACKGROUND

Machines such as, but not limited to, track-type tractors, are used for performing various operations. Typically, the machines include a number of engine mounting brackets which are coupled to a frame of the machine. The engine mounting brackets are structured to provide mounting support for an engine.

The engine mounting brackets are generally manufactured using various fabrication methods. Typically, a current mounting structure includes a number of steel plates that are joined together through a welding process. For example, the current mounting structure is formed using three plates, which are welded together, and a cup shaped structure that is tilted. As a result, the current mounting structure requires at least three plates which are welded together and the cup shaped structure, to form the engine mounting bracket. Such a structure however, may be difficult to manufacture, may increase the cost of production, may have more weight, and may have durability issues. Therefore, there is a need for an improved mounting structure which has improved durability, cost effective, and easy to manufacture.

U.S. Pat. No. 3,871,462 hereinafter referred to as '462 reference, describes a vehicle main frame which is incorporated in a track-type earthmoving vehicle or tractor. The '462 reference describes an engine which is removably secured to the vehicle main frame by a number of resilient mounts in a conventional manner. However, such type of resilient mounts may not be cost effective and may have a durability issues. Therefore, there is a need for an improved mounting structure which is cost effective and has improved durability.

### SUMMARY OF THE DISCLOSURE

In one aspect of the present disclosure, a mounting assembly for mounting an engine of a machine is provided. The mounting assembly includes a bracket having a first portion. The first portion is adapted to attach to a frame of the machine. A second portion is coupled to the first portion. The second portion includes a first member having a first end. The first end includes a first annular opening. A second member having a second end. The second end includes a second annular opening. A third member is sandwiched between the first member and the second member. The third member having a third end, and a first surface. The first surface is indicative of a curved surface. The first end, the second end, and the third end are being coplanar with each other. The bracket is manufactured as a single component, and is disposed on the frame of the machine at a predetermined angle to mount the engine.

Other features and aspects of this disclosure will be apparent from the following description and the accompanying drawings.

### BRIEF DESCRIPTION OF THE DRAWINGS

FIG. 1 is a side view of an exemplary machine, in accordance with the concepts of the present disclosure;

FIG. 2 is a perspective view of a frame assembly of the machine of FIG. 1 showing a bracket coupled to a frame;

FIG. 3 is a perspective view of the frame assembly of the machine of FIG. 1 showing an engine mounted on the bracket; and

FIG. 4 is a perspective view of the bracket of the machine of FIG. 1.

### DETAILED DESCRIPTION

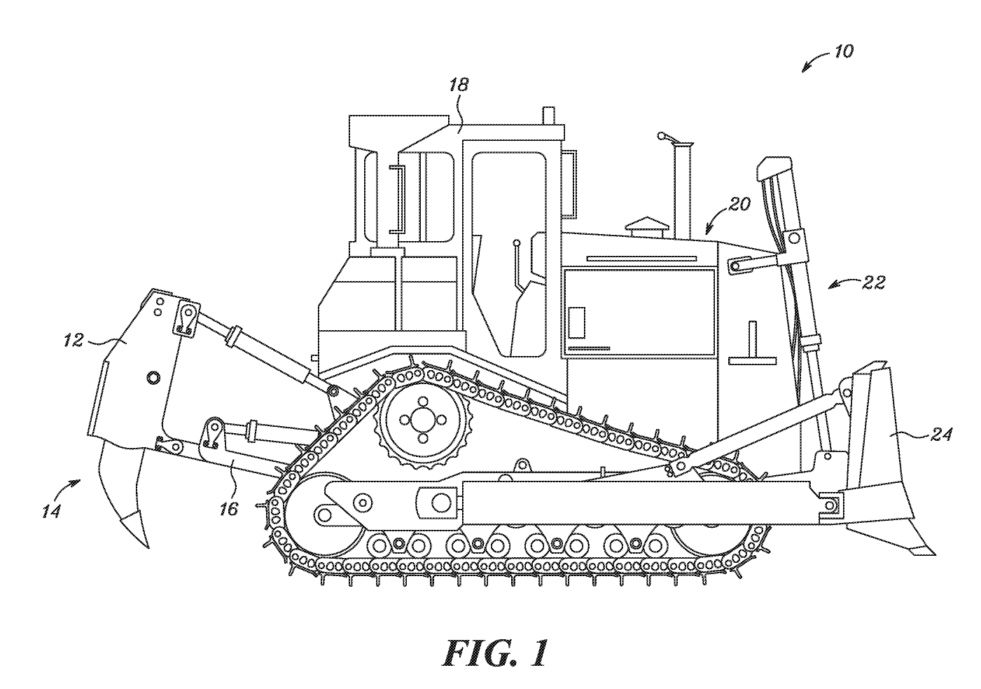

Referring to FIG. 1, an exemplary machine 10 is illustrated. The machine 10 includes a ripper tool 12 which is disposed at a first end 14 of the machine 10. The ripper tool 12 is utilized for ripping operations such as, but not limited to, to loosen hardened ground or break up rock formations. The ripper tool 12 is coupled to a ripper frame assembly 16. Further, the machine 10 includes an operator cab 18 and an engine assembly 20. The engine assembly 20 is disposed at a second end 22 of the machine 10 and includes an engine (not shown) which is configured to provide power to the machine 10.

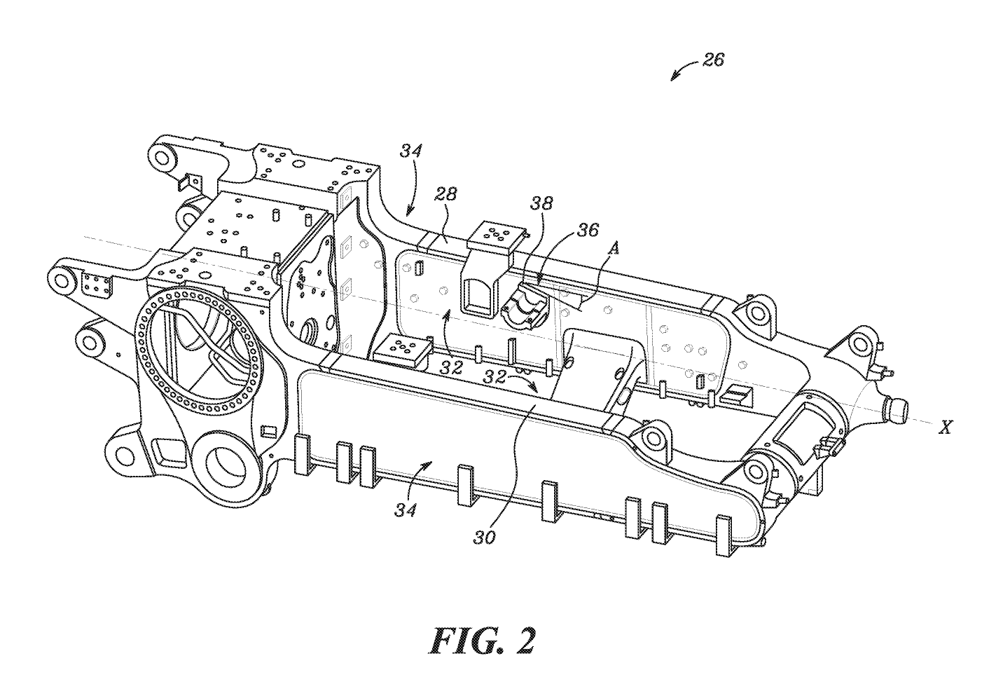

The machine 10 further includes a blade 24 which is disposed at the second end 22 of the machine 10. The blade 24 is utilized for various operations such as, but not limited to, pushing materials such as sand, dirt, and rubble. Further, the machine 10 includes a frame assembly (not shown). The detailed description of the frame assembly (not shown) is described later in conjunction with FIG. 2. The machine 10 may further include various other components such as, but not limited to, a track, or a drive sprocket. For the purpose of simplicity, the various other components are not labeled in FIG. 1. It will be apparent to one skilled in the art that the machine 10 shown in FIG. 1 is a track-type tractor. However, the machine 10 may be any other tracked machine such as, but not limited to, a track-type loader, without departing from the scope of the disclosure.

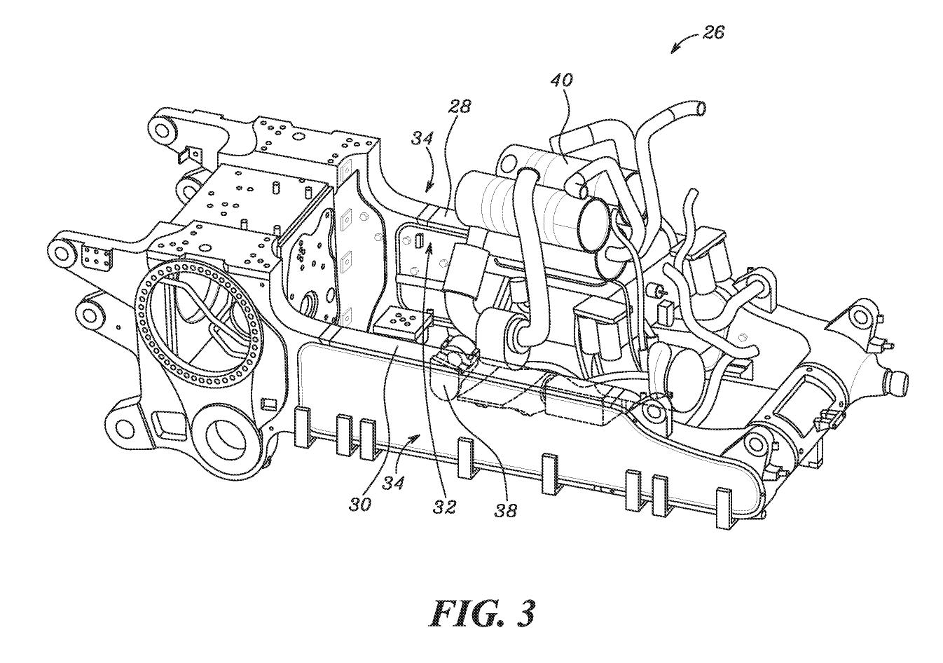

Referring to FIGS. 2 and 3, a frame assembly 26 of the machine 10 is illustrated. The frame assembly 26 includes a pair of frames 28, 30. It should be noted that the frames 28, 30 are disposed in parallel relation to a longitudinal axis, “X”. The frames 28, 30 correspond to structures that provide mounting support for various components of the machine 10, and handle operational loads produced by operating the machine 10. Each of the frames 28, 30 has a first side 32 and a second side 34. It should be noted that the engine assembly 20 (shown in FIG. 1) of the machine 10 is coupled to the frame assembly 26 via a mounting assembly 36.

The mounting assembly 36 having a pair of brackets 38 (shown in FIG. 2) which are welded to the frames 28, 30 of the frame assembly 26. It should be noted that the two brackets 38 are welded to each of the frames 28, 30 of the frame assembly 26 at a predetermined angle on each of the frames 28, 30. As an example, the bracket 38 is welded to the frame 28 in such a way that the bracket 38 is tilted forward at the predetermined angle, “A” of about 15 degree to accommodate installation of an engine 40 (shown in FIG. 3). In the accompanying figures, only the single bracket 38 is illustrated for exemplary purposes, without departing from the scope of the present disclosure. It will be apparent to one skilled in the art that the predetermined angle mentioned above is provided only for explanation purposes. The predetermined angle may be some other angle as well depending on an installation of the engine 40 and a size/shape of the machine 10, without departing from the scope of the disclosure.

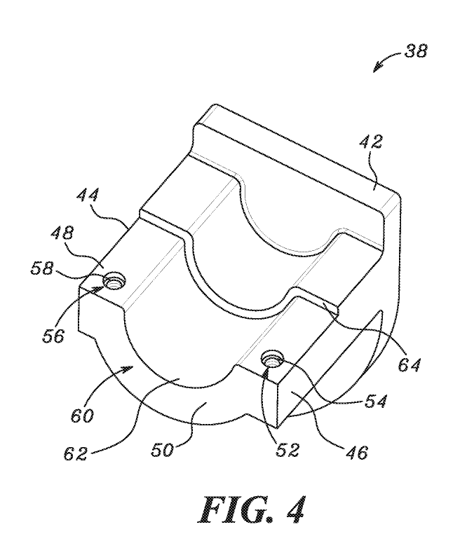

Referring to FIG. 4, the bracket 38 having a first portion 42 and a second portion 44. It should be noted that the first portion 42 and the second portion 44, of the bracket 38, are integrated as a single component. The first portion 42 of the bracket 38 is adapted to attach to the frame 28 (shown in FIG. 2) of the frame assembly 26 (shown in FIG. 2), by using various techniques such as, but not limited to, welding. As an example, in such case, the first portion 42 of the bracket 38 is disposed at the first side 32 (shown in FIG. 2) of the frame 28. On the other hand, the second portion 44 of the bracket 38 is coupled to the first portion 42. The second portion 44 is adapted for mounting the engine 40 (shown in FIG. 3) of the machine 10. The second portion 44 includes a first member 46, a second member 48, and a third member 50. The first member 46 having a first end 52 which has a first annular opening 54. Similarly, the second member 48 having a second end 56 which has a second annular opening 58.

Further, the third member 50 is sandwiched between the first member 46 and the second member 48. The third member 50 having a third end 60 and a first surface 62. The first surface 62 is indicative of a curved surface. Further, the first end 52, the second end 56, and the third end 60 are being coplanar with each other. It should be noted that a design of the second portion 44 of the bracket 38 is such that the second portion 44 has a part 64 which is protruding outwards i.e., each one of the first member 46, the second member 48, and the third member 50, having the part 64 which is protruding outwards. It should be noted that the bracket 38 is fillet welded to the frame 28, without departing from the scope of the disclosure.

It will be apparent to one skilled in the art that a shape of the first surface 62 mentioned above has been provided only for explanation purposes, without departing from the scope of the disclosure. It should be noted that coupling of one of the pair of brackets 38 on to the frame 28 is explained above, however, it will be apparent to one skilled in art that another one of the pair of brackets 38 is coupled with respect to the frame 30 in a similar manner, without departing from the scope of the disclosure.

It should be noted that the bracket 38 of the machine 10 is manufactured by a casting process which is a steel casting. It will be apparent to one skilled in the art that the bracket 38 respectively mentioned above has been provided only for illustration purposes. Other designs, construction materials of the bracket 38, may also be utilized, without departing from the scope of the disclosure.

### INDUSTRIAL APPLICABILITY

The present disclosure provides the mounting assembly 36 for mounting the engine 40 of the machine 10. The mounting assembly 36 includes the bracket 38 which is manufactured as a single component. The bracket 38 is a single piece design which integrates the first portion 42 and the second portion 44, for mounting the engine 40. Further, the bracket 38 is manufactured by the casting process that is cost effective. Also, the bracket 38 manufactured by casting offers better structural strength and is lighter in weight as compared to conventional brackets fabricated using multiple pieces by welding. Further, the casting process reduces time and labor effort during manufacturing of the bracket 38.

Further, the design of the second portion 44 of the bracket 38 is such that the second portion 44 has the part 64 which is protruding outwards to provide structural strength to the bracket 38. Thus, the bracket 38 has improved durability, cost effective, eliminates need of welding different parts to make a single bracket, smaller in size, lighter in weight, and easy to manufacture.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A mounting assembly for mounting an engine of a machine, the mounting assembly comprising:
a bracket having:
a first portion adapted to attach to a frame of the machine; and
a second portion coupled to the first portion, the second portion including:
a first member having a first end, the first end having a first annular opening;
a second member having a second end, the second end having a second annular opening; and
a third member sandwiched between the first member and the second member, the third member having a third end, and a first surface, the first surface is indicative of a curved surface;
wherein the first end, the second end, and the third end are being coplanar with each other;
wherein the bracket is manufactured as a single component, and is disposed on the frame of the machine at a predetermined angle to mount the engine.
